(19) United States
(12) Patent Application Publication
(10) Pub. No.: US 2011/0225725 A1
(43) Pub. Date: Sep. 22, 2011

(54) Portable Eyewash Assembly

(76) Inventor: Steven A. Kersten, Chicago, IL (US)

(21) Appl. No.: 13/050,720

(22) Filed: Mar. 17, 2011

Related U.S. Application Data
(60) Provisional application No. 61/315,274, filed on Mar. 18, 2010.

(51) Int. Cl. A61H 33/00

(52) U.S. Cl. 4/620

(57) ABSTRACT

A portable eyewash assembly comprising a keg-style container filled with liquid under pressure, eyewash components for emergency flushing of one's eyes, and an adapter connecting the eyewash components to the keg in fluid communication. Additionally, the eyewash assembly can include a handheld hose component for other, non-eye related emergencies connected to the adaptor. Additional components, such as a pressure gauge, relief valve and air in-take valve can also be connected to the adapter.

### CROSS-REFERENCE TO RELATED APPLICATIONS

The present Application claims the benefit of U.S. Provisional Application No. 61/315,274, filed Mar. 18, 2010, the contents of which are incorporated herein by reference.

### FEDERALLY SPONSORED RESEARCH OR DEVELOPMENT

N/A

### FIELD OF THE INVENTION

The present invention generally relates to portable eyewash assemblies, and more particularly, to a portable emergency eyewash assembly utilizing a container, such as a keg-style container typically manufactured for beer, to contain water under pressure for the eyewash assembly and a multi-use adaptor coupled between the container and eye wash components of the assembly.

### DESCRIPTION OF THE PRIOR ART

Emergency equipment, such as emergency showers and emergency eyewashes, are necessary in certain environments. For example, such equipment is needed in laboratories and other similar facilities in the event caustic chemicals or other irritants get on one's body or in one's eyes. The showers and eyewashes are used in such circumstances to wash away the chemical or irritant.

Often the emergency shower or eyewash is connected to the main water line, or to a dedicated water line, for providing water under pressure. However, in some instances, a portable shower or eyewash having its own supply of water under pressure is required. In particular, this is necessary if a water line is not available.

The present invention provides a portable eyewash assembly (which can also include a handheld drench hose assembly or component) that includes a portable container of water, or other suitable liquid, under pressure.

### SUMMARY OF THE INVENTION

The present invention provides a portable eyewash assembly for rinsing eyes. The eyewash assembly utilizes a portable container, such as a pressurized vessel or beer keg-style container (hereafter sometimes referred to simply as “keg”), to hold water for the assembly under pressure. The keg is extremely durable and can hold a sufficient amount of water (or other liquid suitable for use as an eyewash) under pressure. The assembly further includes a tri-clamp adapter having a variety of fittings for connecting eyewash components to the keg. A handheld shower or drench hose can also be connected to a container through the tri-clamp adapter and be included as a component of the portable eyewash assembly. Unlike typical beer kegs, the keg of the present invention is provided with an opening suitable for coupling with the adapter.

In accordance with one aspect of the invention, a portable eyewash assembly comprises a container, holding water under pressure, eyewash components including a first eye spray head and a second eye spray head coupled to the container, and an activation handle. The assembly further includes a tri-clamp adapter coupled between the container and the eyewash components. The adapter is configured to connect the eyewash components to the container, as well as other components of the assembly.

The tri-clamp adapter can include a generally cylindrical body having a lower flange extending radially outward from the body. An upper, outwardly threaded fitting can extend upward from a top of the adapter for connection to eye wash components. A lower, internally threaded fitting or opening is provided to fluidly connect the adapter to the container. The adapter can include additional internally threaded fittings or openings on the side of the body for connection to other components, such as an air-intake valve.

The portable eyewash assembly can further include a pressure relief valve connected to the adapter through one of the fittings in the body, and a pressure gauge—also connected to the adapter through one of the fittings—for determining the pressure of the water in the container. The assembly can also include a handheld drench hose connected to another of the fittings in the tri-clamp adapter. The handheld drench hose can act as an emergency body spray.

In accordance with another aspect of the invention, a portable eyewash assembly comprises a portable container holding a liquid (such as water or saline) under pressure. The eyewash assembly further includes eyewash components for spraying the liquid into a user's eyes upon activation of the assembly, and an adapter having a first fitting for connection to the eyewash components, and a second fitting for connection to the portable container. A handle is coupled to the adapter for activating flow of the liquid from the container to the eyewash components.

The portable eyewash assembly can further comprise a pressure regulator coupled between the adapter and the eyewash components. The pressure regulator is for maintaining optimal pressure of the flow of liquid from the container to the eyewash components during use.

The portable eyewash assembly can also further comprise a pressure gauge connected to the adapter through a third fitting in the adapter. The pressure gauge is used for determining the pressure of the liquid in the container.

The eyewash components can include a first eye spray head and a second eye spray head. The eye spray heads can be fluidly coupled to the adapter through tubing.

In addition to the eyewash components, the portable eyewash assembly can further include a handheld drench hose connected to the adapter fitting. The drench hose can be utilized in non-eye related emergencies.

The container holding the liquid under pressure is a generally cylindrical keg. Such kegs are typically formed from stainless steel. The keg can include an upper rim having handles for carrying or moving the keg.

In accordance with yet another embodiment of the invention, a portable eyewash assembly comprises a container filled with a liquid under pressure and eyewash components coupled to the container by an adapter. The adapter is configured to have a body portion with a first fitting extending from an upper portion of the body portion and a second fitting in a bottom portion of the body. The first fitting is connected to the eyewash components and the second fitting is connected to the container wherein the adapter provides fluid communication between the container and the eyewash components during use. A valve is coupled to the adapter for controlling the flow of liquid from the container to the eyewash components. An activation handle is connected to the valve to initiate and control the flow of liquid to the eyewash components.

The assembly can include additional fittings in the side of the body of the adapter. The fittings can be used to connect a drench hose, pressure relief valve, pressure gauge, air in-take valve or other similar items.

The adapter can be formed (e.g., machined) from a single piece of material, such as brass or aluminum. The adapter can include a flange extending radially outward proximate the bottom portion of the body. A clamp can be used to secure the flange on the adapter body to an opening of the container.

The first fitting of the adapter is generally cylindrical and includes an external threading for connection to the valve and activation handle. The second fitting is an internally threaded opening in the bottom of the adapter for receiving an externally threaded tube extending upward from the container. Other fittings are internally threaded openings in the side of the body of the adapter.

The eyewash components include a first eye spray head and a second eye spray head connected by tubing to the adapter. The spray heads include removable covers that can be hingedly connected thereto.

Further aspects of the invention are disclosed in the description of the invention including the Figures.

### BRIEF DESCRIPTION OF THE DRAWINGS

To understand the present invention, it will now be described by way of example, with reference to the accompanying drawings in which:

FIG. 1 is a perspective view of a tri-clamp adapter for use in the present invention;

FIG. 2 is a top plan view of the tri-clamp adapter of FIG. 1;

FIG. 3 is a side plan view of the tri-clamp adapter of FIG. 1;

FIG. 4 is a bottom plan view of the tri-clamp adapter of FIG. 1;

FIG. 5 is a perspective view of a portable eyewash assembly of the present invention;

FIG. 6 is an exploded perspective view of the portable eyewash assembly shown in FIG. 5;

FIG. 7 is a perspective view of the eyewash components of the eyewash assembly shown in FIG. 5;

FIG. 8 is a top plan view of the eyewash components of FIG. 7; and,

FIG. 9 is front plan view of the eyewash components of FIG. 7.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

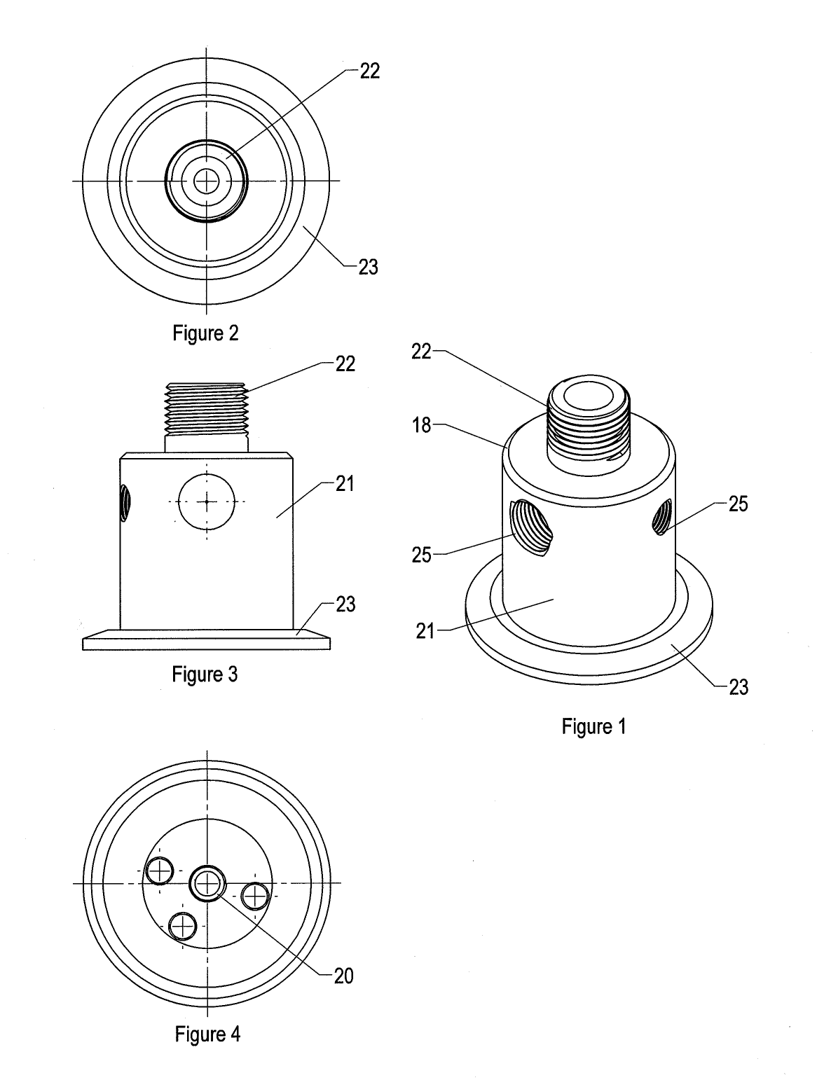

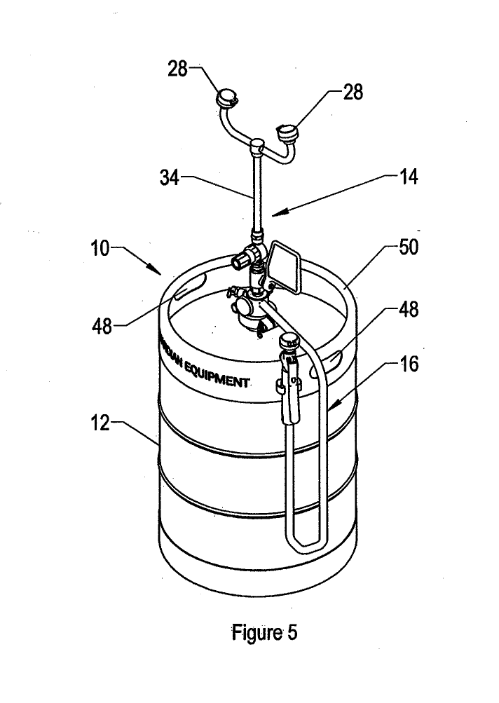

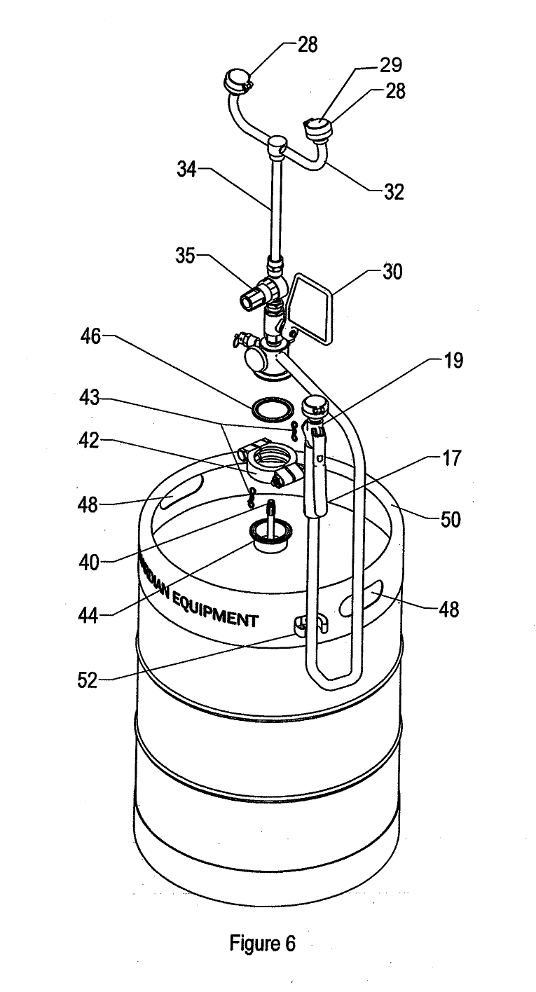

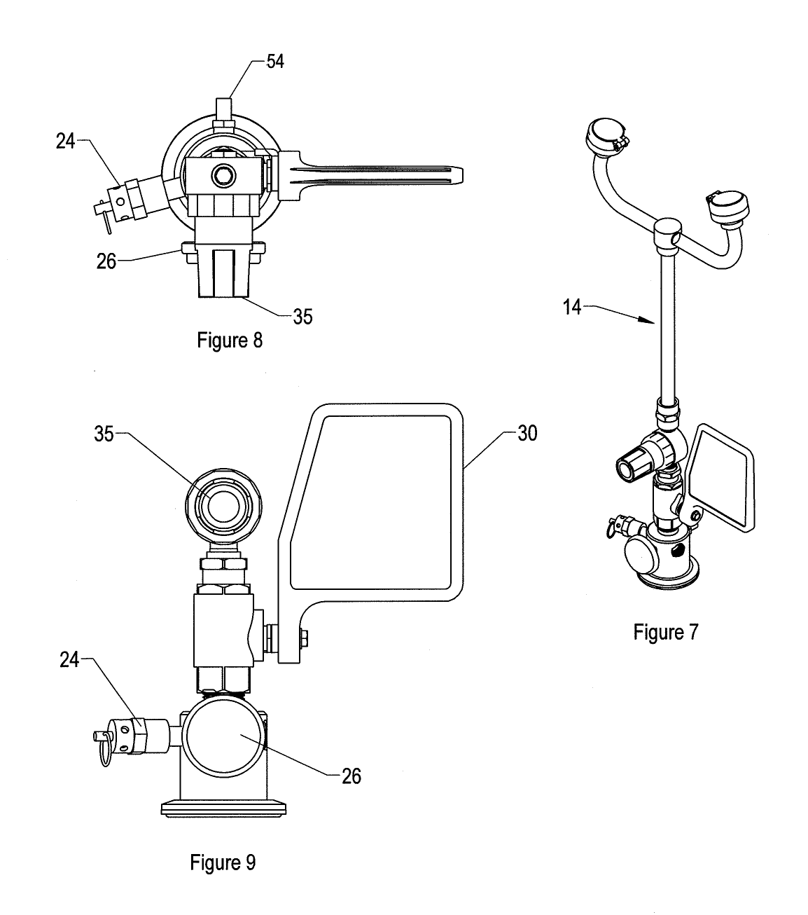

FIGS. 1-9 disclose a portable eyewash assembly 10 in accordance with the present invention. Referring to FIGS. 5 and 6, the eyewash assembly 10 includes a container in the form of a keg-style container typically used for beer 12 connected to eyewash components 14. The keg 12 is generally cylindrical with integrally formed handles 48 formed in a rim structure 50 extending upward from a top of the keg 12. The keg is typically designed to hold approximately fifteen gallons of liquid under pressure.

Additionally, a handheld drench hose assembly 16 having a first end connected to the portable eyewash assembly 10 can be included as a component of the eyewash assembly 10. The hose assembly 16 is provided with a handle 17 connected at a second end of the hose for operating a squeeze valve in a shower head 19. The shower head 19 can be removably connected to the outside of the container 12 via a clip 52.

To enable the eyewash components 14 and drench hose assembly 16 to connect to the keg 10, a tri-clamp adapter 18 is provided as shown in FIGS. 1-4. The tri-clamp adapter 18 includes a generally cylindrical body 21 with an outwardly extending flange 23 extending from a bottom portion of the body 21.

The tri-clamp adapter 18 includes a first, upper externally threaded fitting 22 for connecting the tri-clamp adapter 18 to the eyewash components 14 and a second, lower internally threaded fitting 20 for connecting the adapter 18 to the keg 12. The upper fitting 22 extends upward from a top portion of the adapter body 21.

The tri-clamp adapter 18 also includes one or more, internally threaded fittings 25 in the side of the body 21. One such fitting is provided for connecting the tri-clamp adapter 18 to the handheld drench hose assembly 16. Additional internally threaded fittings 25 are provided in the body 21 of the tri-clamp adapter 18 for a pressure relief valve 24, and air in-take valve 54 and a pressure gauge 26.

The tri-clamp adapter 18 can be machined from brass, aluminum or other suitable material. The adapter 18 can be formed from a single piece of material.

Referring to FIGS. 5-9, the eyewash components 14 of the portable eyewash assembly 10 include two eye spray heads 28 with removable flip covers 29 hingedly connected to the spray heads 28. The eye spray heads 28 are connected or coupled to the upper fitting 22 of the tri-clamp adapter 18 through tubing 32, 34, and are configured to simultaneously spray in a user's right and left eyes (when both flip covers are opened). While a dual eyewash configuration is shown, other eye wash configurations can be used.

An activation valve 27 connected to a flag handle 30 is interposed between the tubing 34 and the upper fitting 22. The flag handle 30 opens and closes the valve 27 to activate the eyewash components. The handle 30 and valve 27 allow liquid under pressure to flow from the container 12 to the eye spray heads 28 when opened.

The handle is provided with a large, easily visible, flat surface. Printing and/or other indicia or graphics can be placed on the flat surface of the handle for quick identification during an emergency.

The eyewash assembly 10 is shown in FIGS. 8 and 9 without the eye spray heads 28 and tubing 32, 34 in place.

Referring to FIG. 6, the tri-clamp adapter 18 is connected to an externally threaded copper tube 40 extending upward from an opening having a seat 44 at the top of the keg 12. A clamp 42 having bolts is secured about the flange 23 at the bottom of the adapter 18 and the seat 44. Safety pins 43 can be secured to the bolts of the clamp 42. A gasket 46 is positioned between the flange 21 and seat 44.

The tri-clamp adapter 18 shown in the Figures has a height of 2 and 45/64 inches and the body 19 has a diameter of 1.750 inches. The fitting 22 on the top of the tri-clamp adapter 18 has a diameter of ½ inches. The side and bottom fittings of the tri-clamp adapter 18 are either ⅛ inches or ⅜ inches.

A regulator valve 35 is positioned between the activation valve and the eye spray heads 28. The regulator valve 35 is provided for maintaining optimal pressure of the flow of liquid during use.

The keg 12 is sanitized and filled with clean potable water. A bacteriostatic additive is supplied to protect against growth of bacteria, fungus, algae and acanthamoeba inside the unit.

After being filled with water or other liquid, the keg 12 is pressurized to 80 pounds per square inch (psi). At this pressure, the assembly 10 is configured to provide a minimum of 0.4 gallons of water per minute (GPM) for fifteen minutes. The pressure regulator valve 35 ensures an optimal flow of water during use.

Many modifications and variations of the present invention are possible in light of the above teachings. It is, therefore, to be understood within the scope of the appended claims the invention may be protected otherwise than as specifically described.

I claim:

1. A portable eyewash assembly comprising:
a portable container holding a liquid under pressure;
eyewash components for spraying the liquid into a user's eyes upon activation of the assembly;
an adapter having a first fitting for connection to the eyewash components, a second fitting for connection to the portable container, and a third fitting for connection to a drench hose; and,
a handle coupled to the adapter for activating flow of the liquid from the container to the eyewash components.

2. The portable eyewash assembly of claim 1 further comprising a pressure regulator coupled between the adapter and the eyewash components, the pressure regulator for maintaining optimal pressure of the flow of liquid from the container to the eyewash components during use.

3. The portable eyewash assembly of claim 2 further comprising a pressure gauge connected to the adapter through a fourth fitting in the adapter, the pressure gauge for determining the pressure of the liquid in the container.

4. The portable eyewash assembly of claim 1 wherein the eyewash components include a first eye spray head and a second eye spray head.

5. The portable eyewash assembly of claim 1 further including a pressure relief valve connected to the adapter through a fourth fitting and an air in-take valve connected to the adapter through a fifth fitting.

6. The portable eyewash assembly of claim 1 wherein the container holding liquid under pressure is a generally cylindrical stainless steel keg.

7. The portable eyewash assembly of claim 1 further comprising a clamp connecting the adapter to the container.

8. A portable eyewash assembly comprising:
a container filled with a liquid under pressure;
eyewash components coupled to the container;
an adapter having a body portion with a first fitting extending from an upper portion of the body portion and a second fitting in a bottom portion of the body, the first fitting connected to the eyewash components, the second fitting connected to the container wherein the adapter provides fluid communication between the container and the eyewash components during use, the adapter having a third fitting in the body portion connected to a pressure gauge;
a valve coupled to the adapter for controlling the flow of liquid from the container to the eyewash components; and,
a handle connected to the valve to operate the valve.

9. The portable eyewash assembly of claim 8 further comprising:
a fourth fitting in the body of the adapter;
a drench hose connected to the fourth fitting.

10. The portable eyewash assembly of claim 8 further comprising:
a fourth fitting in the body of the adapter;
a pressure relief valve connected to the fourth fitting.

11. The portable eyewash assembly of claim 10 further comprising:
a fifth fitting in the body of the adapter;
an air in-take valve connected to the fifth fitting.

12. The portable eyewash assembly of claim 8 wherein the body of the adapter is generally cylindrical.

13. The portable eyewash assembly of claim 11 wherein the adapter is one piece.

14. The portable eyewash assembly of claim 8 wherein the adapter includes a flange extending radially outward proximate the bottom portion of the body.

15. The portable eyewash assembly of claim 14 further comprising a clamp wherein the clamp secures the flange on the adapter body to the container.

16. The portable eyewash assembly of claim 8 wherein the first fitting is generally cylindrical and includes an external threading for connection to the valve.

17. The portable eyewash assembly of claim 16 wherein the second fitting is an internally threaded opening in the bottom of the adapter for receiving a tube extending upward from the container.

18. The portable eyewash assembly of claim 17 wherein the third fitting is an internally threaded opening in the side of the body of the adapter.

19. The portable eyewash assembly of claim 8 wherein the eyewash components include a first eye spray head and a second eye spray head.

20. The portable eyewash assembly of claim 17 further comprising a first removable cover on the first eye spray head and a second removable cover on the second eye spray head.
